(19) United States
(12) Patent Application Publication
(10) Pub. No.: US 2017/0160207 A1
(43) Pub. Date: Jun. 8, 2017

(54) MACHINE FOR DETECTING TINY PARTICLES

(71) Applicant: Ming-Sheng Chen, Taichung (TW)

(72) Inventor: Ming-Sheng Chen, Taichung (TW)

(21) Appl. No.: 14/960,349

(22) Filed: Dec. 5, 2015

(51) Int. Cl. G01N 21/94; G01N 21/958; G01N 21/95

(52) U.S. Cl. CPC G01N 21/94; G01N 21/9501; G01N 21/958; G01N 2201/12; G01N 2201/0612; G01N 2201/105

(57) ABSTRACT

A machine for inspecting a face of a transparent plate includes a frame, a carrier module, an optical module and at least two illumination modules. The frame includes an X-axis. The carrier module is adapted for carrying a transparent plate in need of inspection on the frame along the X-axis. The optical module is located on the frame and movable relative to the carrier module and includes at least one detector adapted for rectilinear scanning along a Y-axis perpendicularly intersecting the X-axis of the carrier module at a crossing point. The illumination modules are located on two opposite sides of the X-axis of the frame. Each of the illumination modules includes a laser emitter. The laser emitters are located at a same distance from the crossing point and adapted for emitting rays on the transparent plate at a same angle of 0.5° to 6°.

### BACKGROUND OF INVENTION

1. Field of Invention

The present invention relates to inspection of a transparent plate and, more particularly, to a machine for detecting tiny particles on a face of a transparent element without risks of being affected by a pattern on an opposite face of the transparent plate.

2. Related Prior Art

A conventional mask-inspecting apparatus includes an optical module such as an image sensor, a CCD and a CMOS element to scan a face of a mask to detect contaminant or sediment. For example, when the optical module casts light on an upper face of the mask, which is made of a glass plate that is transparent, a pattern on a lower face of the mask jeopardizes the precision, effect and efficiency of inspection of tiny particles on the upper face of the mask.

Another optical module is based on scanning a mask with a ray such as a laser or an electron beam. The ray casts a small spot of light on the mask. However, such an optical module is expensive. Furthermore, it is difficult to focus in such optical scanning because the mask is made of a perfectly plain transparent plate made of quartz or glass. Moreover, it takes a lot of effort and time to precisely determine the size of a tiny particle because of a shadow on a lateral side of the tiny particle. Hence, the size of tiny particles that can be determined with precision is limited to 50 um×50 um because of such shadow. The precision in the determination of tiny particles smaller than 50 um×50 um is low. In addition, the width of wiring of an integrated circuit is getting smaller, and so is the size of tiny particles that must be found and removed from an integrated circuit. Hence, such a modern optical is getting less satisfactory.

As discussed above, conventional methods or apparatuses for detecting tiny particles are limited regarding efficiency, effectiveness and precision. It is not easy for a person to determine the size of a tiny particle with such conventional methods or apparatuses. The efficiency and yield of related manufacturing of semiconductor are affected.

The present invention is therefore intended to obviate or at least alleviate the problems encountered in prior art.

### SUMMARY OF INVENTION

It is an objective of the present invention to provide an effective and precise machine for determining the size and location of a tiny particle to increase the efficiency and yield of manufacturing of a wafer.

It is another objective of the present invention to provide a machine for detecting tiny particles that are extremely small to satisfy the semiconductor industry.

It is another objective of the present invention to provide a machine for fast and thoroughly scanning a mask.

To achieve the foregoing objectives, the machine includes a frame, a carrier module, an optical module and at least two illumination modules. The frame includes an X-axis. The carrier module is adapted for carrying a transparent plate in need of inspection on the frame along the X-axis. The optical module is located on the frame and movable relative to the carrier module and includes at least one detector adapted for rectilinear scanning along a Y-axis perpendicularly intersecting the X-axis of the carrier module at a crossing point. The illumination modules are located on two opposite sides of the X-axis of the frame. Each of the illumination modules includes a laser emitter. The laser emitters are located at a same distance from the crossing point and adapted for emitting rays on the transparent plate at a same angle of 0.5° to 6°.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a top view of a machine for detecting tiny particles according to the preferred embodiment of the present invention;

FIG. 2 is a top view of an optical module used in the machine illustrated in FIG. 1;

FIG. 3 is a side view of the optical module shown in FIG. 2;

FIG. 4 is a perspective view of a carrier module used in the machine shown in FIG. 1;

FIG. 5 is an exploded view of the carrier module of FIG. 4; and

FIG. 6 is a perspective view of a unit for positioning the carrier module shown in FIGS. 4 and 5.

### DETAILED DESCRIPTION OF PREFERRED EMBODIMENT

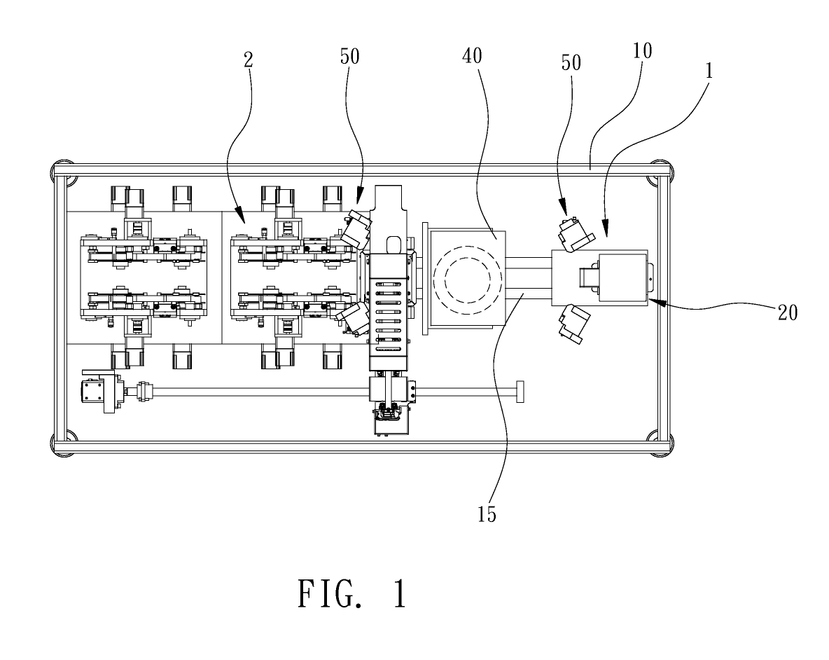

Referring to FIGS. 1 through 3, there is a machine for detecting tiny particles on a transparent plate 80 such as a mask in the semiconductor industry. The machine includes a frame 10, a carrier module 20, an optical module 40 and at least two illumination modules 50. The frame 10 supports the carrier module 20, the optical module 40 and the illumination modules 50. The carrier module 20 carries a transparent plate 80 in need of inspection. The optical module 40 inspects the transparent plate 80. The optical module 40 is rectilinearly movable relative to the carrier module 20. The illumination modules 50 are located around the optical module 40, and each of them casts a spot of light on the transparent plate 80.

The frame 10 does not only support the carrier module 20 and the optical module 40 but also supports controlling elements, pneumatic elements and other related elements. The frame 10 includes a guiding unit 15 that includes at least one rectilinear track (not numbered) and a corresponding groove (not numbered). The carrier module 20 is movable relative to the optical module 40 under the guidance of the guiding unit 15. The guiding unit 15 extends along an X-axis.

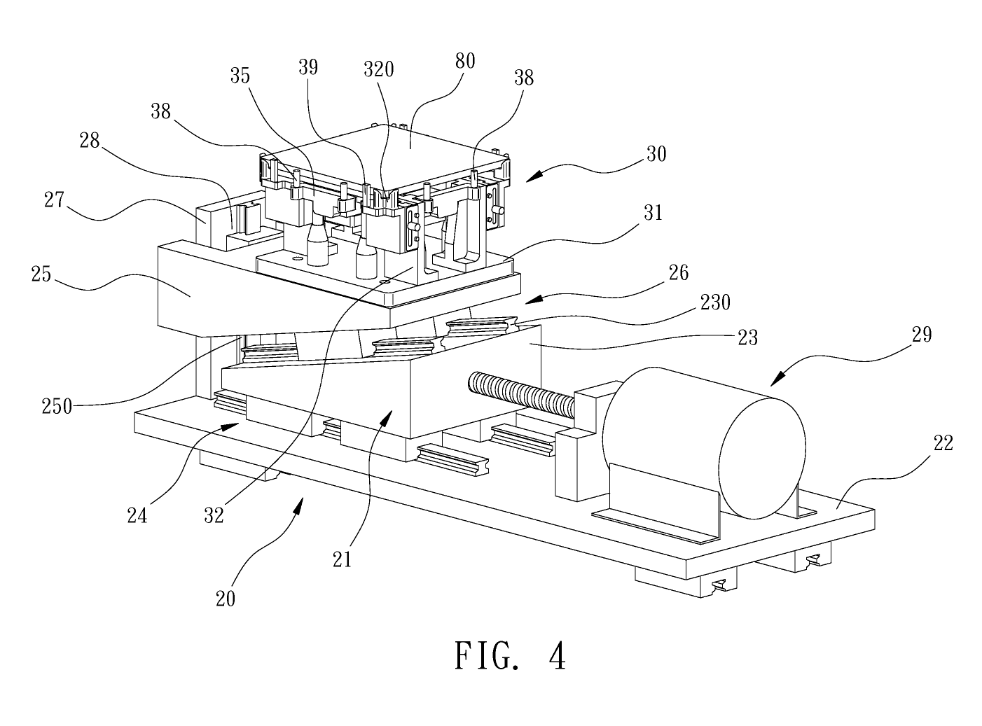

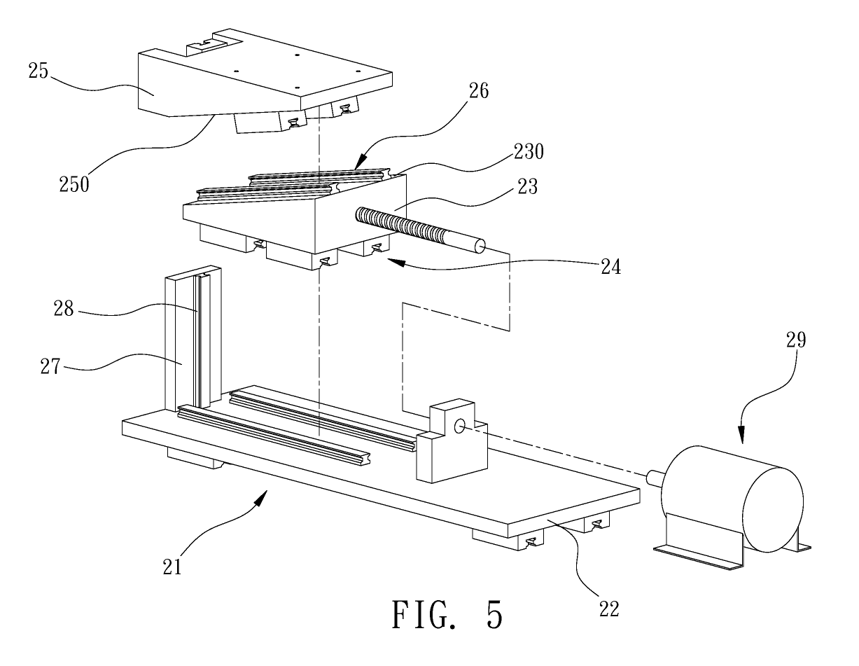

Referring to FIG. 4, the carrier module 20 includes an elevator 21 and a positioning module 30 located on the elevator 21. Referring to FIG. 5, the elevator 21 includes a table 22. A servomotor and a threaded rod (not shown) can be used to rectilinearly move the table 22 relative to the optical module 40 under the guidance of the guiding unit 15 of the frame 10. Movable on the table 22 is a wedge 23 that is formed with a slope 230. Between the wedge 23 and the table 22, there is a guiding unit 24 that includes two rectilinear tracks (not numbered) made on the table 22 and two corresponding grooves (not numbered) made in the wedge 23. The wedge 23 is rectilinearly movable relative to the table 22 under the guidance of the guiding unit 24.

A wedge 25 includes a slope 250 corresponding to the slope 230 of the wedge 23. Between the slope 230 of the wedge 23 and the slope 250 of the wedge 25, there is a guiding unit 26 that includes two rectilinear tracks (not numbered) formed on the table 22 and two corresponding grooves (not numbered) made in the wedge 23.

A vertical plate 27 is located on the table 22. Between the vertical plate 27 and the wedge 25, there is a guiding unit 28 that includes a track (not numbered) made on the vertical plate 27 and a corresponding groove (not numbered) made in the wedge 25. The wedge 25 is movable up and down relative to the vertical plate 27 under the guidance of the guiding unit 28.

A servomotor 29 is located on the table 22. The servomotor 29 is operatively connected to a threaded rod (not numbered) that is inserted in a screw hole (not numbered) made in the wedge 23. The servomotor 29 horizontally moves the wedge 23 on the table 20 so that the wedge 23 in turn vertically moves the wedge 25 on the vertical plate 27 because of the sliding contact of the slope of the wedge 23 and the slope 250 of the wedge 25 and the guidance of the guiding unit 28.

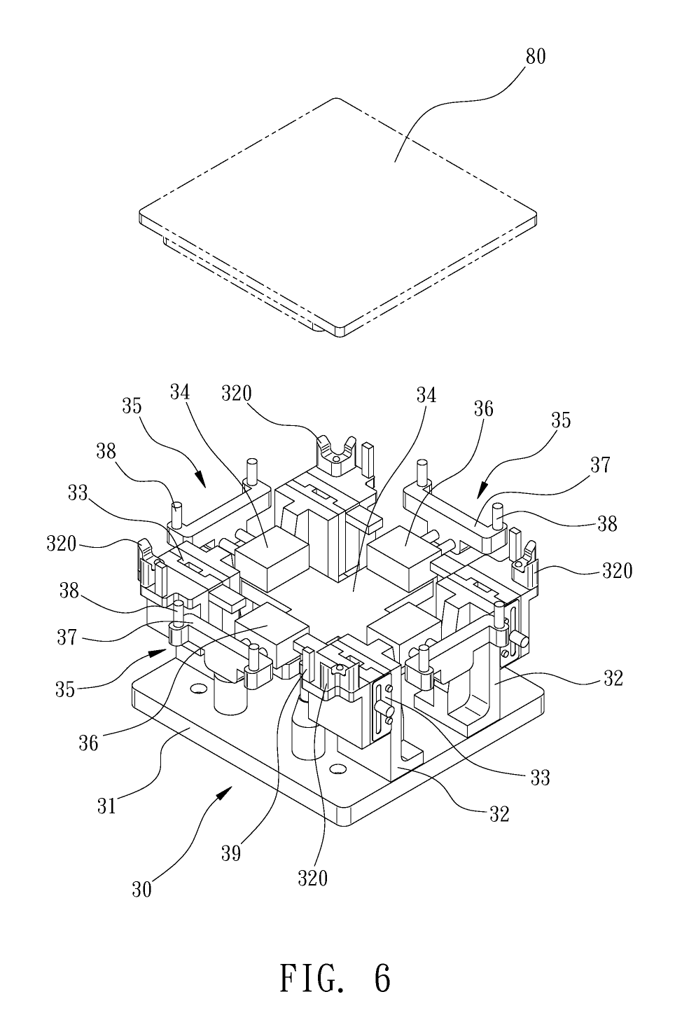

Referring to FIG. 6, the positioning module 30 includes a base plate 31 secured to an upper side of the elevator 21. Four holders 32 are arranged on the base plate 31 corresponding to four corners of the transparent plate 80. Each holder 32 is provided with a block 320 for supporting a corresponding corner of the transparent plate 80. The block 320 can be made of polyetheretherketone (“PEEK”). The transparent plate 80 is vertically laid on the positioning module 30. Between each holder 32 and the corresponding block 320, there is an adjusting unit 33 to adjust the elevation of the corresponding corner of the transparent plate 80 lay the transparent plate 80 precisely horizontally.

A platform 34 is arranged on the base plate 31 of the positioning module 30, in an area defined by the holders 32. The platform 34 is provided with four pushers 35 for contact with four margins of the transparent plate 80. A pneumatic cylinder 36 is provided on a lateral side of each pusher 35 of the platform 34. Each pneumatic cylinder 36 is connected to a beam 37 through two plungers (not numbered). Each beam 37 is provided with at least two stems 38. The stems 38 on each beam 37 are selectively used to contact the transparent plate 80 under the control of the corresponding pneumatic cylinder 36. The stems 38 of the pushers 35 contact the transparent plate 80 when the pushers 35 withdraw. Thus, different transparent plates 80 can be laid in a same position for inspection, and the precision of the inspection is increased. Moreover, on the positioning module 30, there is at least one elevation sensor 39 for sensing the elevation of the transparent plate 80. The elevation sensor 39 is electrically connected to the motor 29 of the elevator 21. On receiving information from the elevation sensor 39, the motor 29 drives the elevator 21, which includes the wedges 23 and 25, to move the transparent plate 80 up or down to compensate for a difference in the thickness of the transparent plate 80.

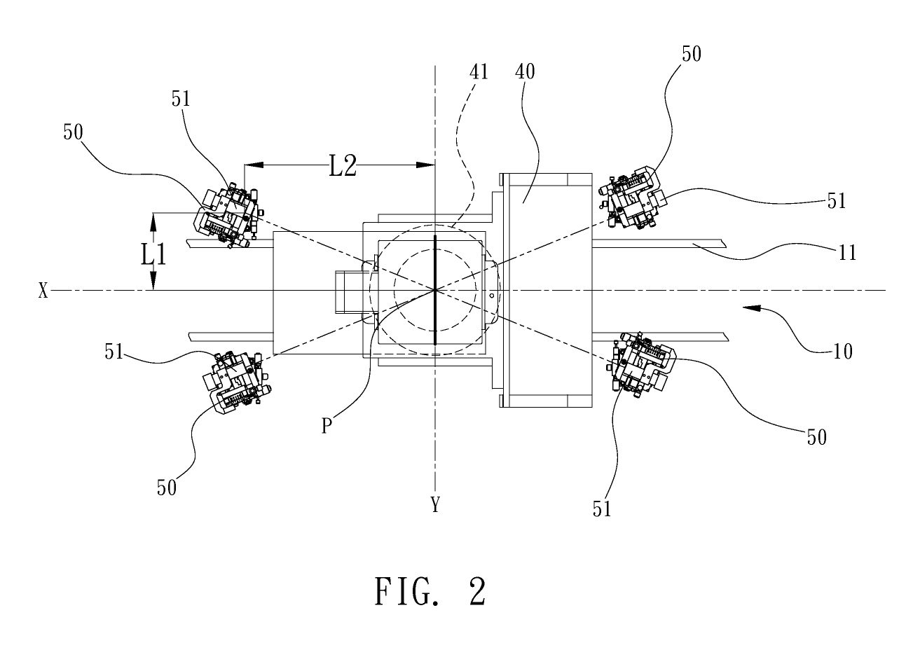

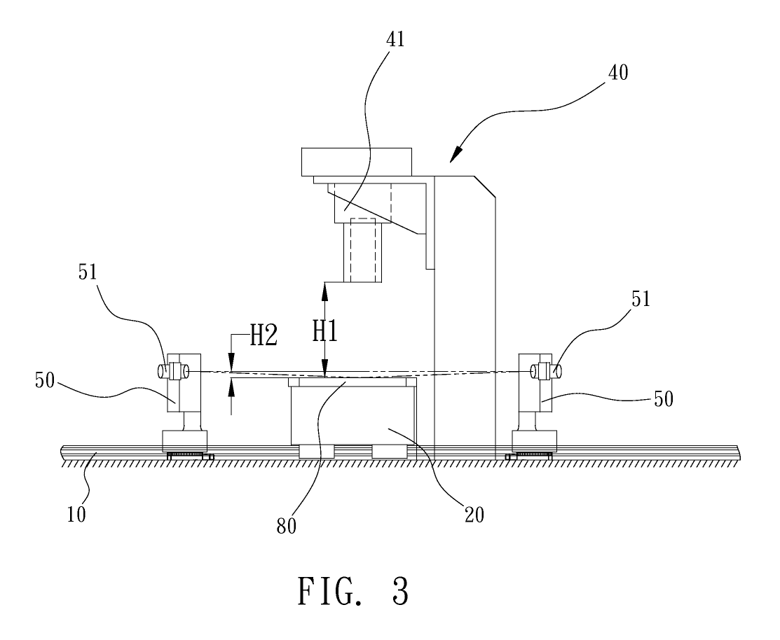

Referring to FIGS. 2 and 3, the optical module 40 includes at least one detector 41 such as a CCD or a CMOS element for rectilinear scanning The detector 41 scans along a Y-axis that perpendicularly intersects the X-axis of the carrier module 20 at a crossing point P. There are preferably two detectors 41 each including a row of CCD or CMOS elements. The detectors 41 inspect the width of the transparent plate 80 or two parallel lateral faces such as lateral faces of a coating on a mask. Hence, the transparent plate 80 only has to be movable relative to the optical module 40 on a horizontal plane along a single axis, and the rate and precision of inspection are increased. Each detector 41 of the optical module 40 is located at an elevation H1 of 280 to 320 millimeters above the transparent plate 80. The elevation H1 is preferably 293 to 305 millimeters to inspect a mask.

There are preferably four illumination modules 50 in two pairs. Each illumination module 50 includes a laser emitter 51 that can be a laser diode such as a red-light laser diode for emitting a ray laser with wavelength of 600 to 700 nanometers. The rays from the laser emitters 51 of the illumination modules 50 in each pair are coplanar, or collinear in a top view such as FIG. 2. The laser emitter 51 of each illumination module 50 is located at a distance L1 of 120 to 130 millimeters from the X-axis. The laser emitter 51 of each illumination module 50 is located at a distance L2 of 300 to 320 millimeters from the Y-axis. The laser emitter 51 of each illumination module 50 is located at an elevation H2 of 3 to 33 millimeters above the transparent plate 80. An angle of 0.5° to 6° exists between the ray and the transparent plate 80.

Preferably, the distance L1 of the laser emitter 51 of each illumination module 50 from the X-axis is 123 to 127 millimeters, and the distance L2 of the laser emitter 51 of each illumination module 50 from the Y-axis 307 to 311 millimeters. Preferably, the elevation H2 of the laser emitter 51 of each illumination module 50 above the transparent plate 80 is 3 to 13 millimeters. Preferably, the angle between the ray and the transparent plate 80 is 0.5° to 3°.

In the inspection of the transparent plate 80, the transparent plate 80 is laid on the blocks 320 of the positioning module 30 of the carrier module 20 referring to FIGS. 4 and 6. The pneumatic cylinders 36 of the pushers 35 move the stems 38 to locate different transparent plates in a same position on the carrier module 20. The elevation sensor 39 of the positioning module 30 determines the thickness of the transparent plate 80 and accordingly instructs the motor 29 of the elevator 21 to move the transparent plate 80 to a desired elevation referring to FIGS. 4 and 5. The detectors 41 of the optical module 40 and the laser emitters 51 of the illumination modules 50 are synchronously activated.

The carrier module 20 carries the transparent plate 80 along the X-axis on the frame 10. When the transparent plate 80 is located under the detectors 41 of the optical module 40, any tiny particle on the transparent plate 80 is manifested by the rays from the laser emitters 51 of the illumination module 50. That is, there is no shadow on any lateral side of the tiny particle since the rays from the laser emitters 51 travel to the tiny particle for a same distance and at a same angle. Only a shadow exists below the tiny particle and is not detected by the detectors 41 of the optical module 40. Hence, the detectors 41 of the optical module 40 precisely detect and determine the location and size of the tiny particle without the risks of being affected by the shadow of the tiny particle. After tests, the optical module 40 has been proven to precisely detect tiny particles of 10 um×10 um.

As discussed above, there are at least two illumination modules 50 that emit rays that travel to any tiny particle for a same distance and at a same angle. Thus, any tiny particle on the transparent plate 80 is manifested because of effective irradiation. With the detectors 41 of the optical module 40 used to scan the transparent plate 80, and the location and size of any tiny particle can quickly and effectively be detected and determined without misjudge. Extremely small tiny particles can be detected to the satisfaction of a semiconductor process. The image of the entire transparent plate 80 is rendered possible, with the location and size of any detected tiny particle marked on the image. An operator can use the optical module 40 to locate any detected tiny particle and take a photograph before the transparent plate 80 is cleaned. The operator can use the optical module 40 to locate the tiny particle and take a photograph after the transparent plate 80 is cleaned. The operator can compare these photographs with each other to determine whether the cleaning is effective. Further manual inspection, study and recording can be conducted. Reasons for flaws on the transparent plate 80 can be found.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A machine for inspecting a face of a transparent plate comprising:
a frame comprising an X-axis;
a carrier module adapted for carrying a transparent plate in need of inspection on the frame along the X-axis;
an optical module located on the frame and movable relative to the carrier module, wherein the optical module comprises at least one detector adapted for rectilinear scanning along a Y-axis perpendicularly intersecting the X-axis of the carrier module at a crossing point; and
at least two illumination modules located on two opposite sides of the X-axis of the frame, wherein each of the illumination modules comprises a laser emitter, wherein the laser emitters are located at a same distance from the crossing point and adapted for emitting rays on the transparent plate at a same angle of 0.5° to 6°.

2. The machine according to claim 1, wherein the laser emitter of each of the illumination module is a red laser diode for casting laser with wavelength of 600 to 700 nanometers.

3. The machine according to claim 1, wherein the detector is located at an elevation of 280 to 320 millimeters from the transparent plate, wherein the laser emitter of each of the illumination modules is located at a distance of 120 to 130 millimeters from the X-axis, wherein the laser emitter of each of the illumination modules is located at a distance of 300 to 320 millimeters from the Y-axis.

4. The machine according to claim 1, wherein the detector is located at an elevation of 293 to 305 millimeters from the transparent plate, wherein the laser emitter of each of the illumination modules is located at a distance of 123 to 127 millimeters from the X-axis, wherein the laser emitter of each of the illumination modules is located at a distance of 307 to 311 millimeters from the Y-axis, wherein the laser emitter of each of the illumination modules is adapted for emitting a ray on the transparent plate at an angle of 0. 5° to 3°.
